(19) United States
(12) Patent Application Publication
(10) Pub. No.: US 2025/0207380 A1
(43) Pub. Date: Jun. 26, 2025

(54) TOILET INCLUDING AN OVERFLOW CONTROL SYSTEM

(71) Applicant: Michel Levesque, Saint-Pie (CA)

(72) Inventor: Michel Levesque, Saint-Pie (CA)

(21) Appl. No.: 18/988,550

(22) Filed: Dec. 19, 2024

Related U.S. Application Data
(60) Provisional application No. 63/614,279, filed on Dec. 22, 2023.

(51) Int. Cl. E03D 11/13; E03D 1/34

(52) U.S. Cl. CPC E03D 11/13; E03D 1/34

(57) ABSTRACT

There is provided a toilet comprising a toilet tank, a toilet bowl, a flush valve, and a toilet overflow control assembly. The toilet overflow control assembly includes an obstruction sensor mounted to the toilet bowl to detect if a water level inside the toilet bowl reaches an overflow water level threshold and a disconnection mechanism mounted to the flush valve and operatively connected to the obstruction sensor. The disconnection mechanism is configurable into an operative configuration wherein the flush actuator is operatively connected to a flapper and a disengaged configuration wherein a flush actuator is disconnected from the flapper if the water level inside the toilet bowl reaches the overflow water level threshold. There is also provided a toilet overflow control assembly for a toilet and a method for preventing toilet overflows.

### CROSS-REFERENCE TO RELATED APPLICATIONS

This application claims priority under 35USC§ 119(e) of U.S. provisional patent application 63/614,279 filed on Dec. 22, 2023, the specification of which is hereby incorporated by reference.

### TECHNICAL FIELD OF THE INVENTION

The technical field relates to toilets and, more particularly, to an overflow control system for a toilet. It also relates to a method for preventing toilet overflows.

### BACKGROUND

Toilet bowl drains can be partially or totally clogged for many reasons. When it happens, water cannot flow normally through the toilet bowl drain and the water level gradually rises into the toilet bowl when the flush actuator is activated. Once the water level reaches a rim of the toilet bowl, the water overflows outside the toilet bowl, causing potential damages.

Toilet overflows are frequent in nursing homes, wherein residents can block the toilet bowl drain with everyday objects. They then actuate a flush actuator several times without realizing that the toilet drain is clogged, and a toilet overflow is happening.

In view of the above, there is a need for toilet overflow control system which would be able to overcome or at least minimize some of the above-discussed prior art concerns.

### BRIEF SUMMARY OF THE INVENTION

It is therefore an aim of the present invention to address the above-mentioned issues.

According to a general aspect, there is provided a toilet comprising: a toilet tank having a tank drain and defining a flush water receptacle; a toilet bowl having a cavity in water communication with the flush water receptacle of the toilet tank; a flush valve mounted to the toilet tank and including a flush actuator, a flapper mounted to the toilet tank and superposable to the tank drain to obstruct same, and a link operatively connecting the flush actuator and the flapper, the flapper being configurable into a closed configuration wherein the flapper obstructs the tank drain and an open configuration allowing water communication between the flush water receptacle and the tank drain; and a toilet overflow control assembly including an obstruction sensor mounted to the toilet bowl to detect if a water level inside the cavity of the toilet bowl reaches an overflow water level threshold and a disconnection mechanism mounted to the flush valve and operatively connected to the obstruction sensor, the disconnection mechanism being configurable into an operative configuration wherein the flush actuator is operatively connected to the flapper and a disengaged configuration wherein the flush actuator is disconnected from the flapper if the obstruction sensor detects that the water level inside the cavity of the toilet bowl reaches the overflow water level threshold.

In accordance with an embodiment, the obstruction sensor comprises a safety float configurable into a normal configuration and an overflow configuration corresponding to the water level inside the cavity of the toilet bowl reaching the overflow water level threshold.

In accordance with an embodiment, the safety float is pivotally mounted to the toilet tank, a position of the safety float in the normal configuration being lower than in the overflow configuration.

In accordance with an embodiment, the disconnection mechanism comprises an electromagnet assembly.

In accordance with an embodiment, the electromagnet assembly comprises an electromagnet support mounted to one of the flush actuator and the link, and a metallic element mounted to the other one of the flush actuator and the link, the electromagnet support and the metallic element being engaged together in the operative configuration and being disengaged from one another in the disengaged configuration.

In accordance with an embodiment, the flush actuator comprises a pivotally-mounted float rod and at least one of a lever and a button operatively connected to the float rod to pivot same, and wherein the electromagnet support is mounted to the float rod.

In accordance with an embodiment, the electromagnet assembly is located above a maximum water level inside the flush water receptable.

In accordance with an embodiment, the toilet overflow control assembly further comprises a controller assembly operatively connected to at least one of the obstruction sensor and the disconnection mechanism.

In accordance with an embodiment, the toilet overflow control assembly comprises an alarm and the obstruction sensor is operatively connected to the alarm to configure the alarm is an alarm state when a toilet bowl overflow is detected.

In accordance with an embodiment, the flapper is pivotally mounted to the toilet tank and covers the tank drain in the closed configuration.

In accordance with an embodiment, the toilet overflow control assembly further comprises a battery operatively connected to the disconnection mechanism.

According to another general aspect, there is provided a toilet overflow control assembly for a toilet including a toilet tank, a toilet bowl, and a flush valve mounted to the toilet tank. The toilet overflow control assembly comprises: an obstruction sensor engageable with the toilet bowl to detect if a water level inside a cavity of the toilet bowl reaches an overflow water level threshold; and a disconnection mechanism connectable to the flush valve between a flush actuator and a flapper of the flush valve and operatively connected to the obstruction sensor, the disconnection mechanism being configurable into an operative configuration wherein the flush actuator is operatively connected to the flapper and a disengaged configuration wherein the flush actuator is disconnected from the flapper if the obstruction sensor detects that the water level inside the cavity of the toilet bowl reaches the overflow water level threshold.

In accordance with an embodiment, the obstruction sensor comprises a safety float configurable into a normal configuration and an overflow configuration corresponding to the water level inside the cavity of the toilet bowl reaching the overflow water level threshold.

In accordance with an embodiment, the flush valve further comprises a link connecting the flapper to the flush actuator, wherein the disconnection mechanism comprises an electromagnet assembly including an electromagnet support mounted to one of the flush actuator and the link, and a metallic element mounted to the other one of the flush actuator and the link, the electromagnet support and the metallic element being engaged together in the operative configuration and being disengaged from one another in the disengaged configuration.

In accordance with an embodiment, the electromagnet assembly is located above a water level inside the toilet tank.

In accordance with an embodiment, the overflow control assembly further comprises a controller assembly operatively connected to the obstruction sensor and the disconnection mechanism and an alarm and the obstruction sensor is operatively connected to the alarm to configure the alarm is an alarm state when a toilet bowl overflow is detected.

In accordance with an embodiment, the toilet overflow control assembly further comprises a battery operatively connected to the disconnection mechanism.

According to still a further general aspect, there is provided a method to prevent a toilet overflow. The method comprises: detecting if a water level inside a cavity of a toilet bowl of a toilet reaches an overflow water level threshold; and if the overflow water level threshold is reached, disconnecting a flush actuator from a flapper of a flush valve mounted to a toilet tank of the toilet.

In an embodiment, the method further comprises actuating an alarm when the water level inside the cavity of the toilet bowl reaches the overflow water level threshold.

In an embodiment, the method wherein disconnecting the flush actuator from the flapper of the flush valve of the toilet comprises cutting power supplied to an electromagnet assembly connecting the flush actuator to the flapper of the flush valve, thereby configuring the flapper in a closed configuration wherein the flapper obstructs a tank drain, thereby preventing water communication between the toilet tank and the cavity of the toilet bowl.

According to a still further general aspect, there is provided a toilet comprising: a toilet tank having a tank drain and defining a flush water receptacle; a toilet bowl in water communication with the flush water receptacle of the toilet tank; a flush valve mounted to the toilet tank and including a flush actuator, a flapper mounted to the toilet tank and superposable to the tank drain to cover same, and a link operatively connecting the flush actuator and the flapper, the flapper being configurable into a closed configuration wherein the flapper covers the tank drain and an open configuration allowing water communication between the flush water receptacle and the tank drain; and a toilet overflow control assembly including an obstruction sensor mounted to the toilet bowl to detect if a water level inside the toilet bowl reaches an overflow water level threshold and a disconnection mechanism mounted to the flush valve and operatively connected to the obstruction sensor, the disconnection mechanism being configurable into an operative configuration wherein the flush actuator is operatively connected to the flapper and a disengaged configuration wherein the flush actuator is disconnected from the flapper if the water level inside the toilet bowl reaches the overflow water level threshold.

According to a still further general aspect, there is provided a toilet overflow control assembly for a toilet including a toilet tank, a toilet bowl and a flush valve mounted to the toilet tank. The toilet overflow control assembly comprises: an obstruction sensor engageable with the toilet bowl to detect if a water level inside the toilet bowl reaches an overflow water level threshold; and a disconnection mechanism connectable to the flush valve between a flush actuator and a flapper thereof and operatively connected to the obstruction sensor, the disconnection mechanism being configurable into an operative connection wherein the flush actuator is operatively connected to the flapper and a disengaged configuration wherein the flush actuator is disconnected from the flapper if the water level inside the toilet bowl reaches the overflow water level threshold.

According to still a further general aspect, there is provided a method to prevent a toilet overflow. The method comprises: detecting if a water level inside a toilet bowl of a toilet reaches an overflow water level threshold; and if the overflow water level threshold is reached, disconnecting a flush actuator from a flapper of a flush valve of the toilet.

The present document refers to a number of documents, the contents of which are hereby incorporated by reference in their entirety.

### BRIEF DESCRIPTION OF THE DRAWINGS

FIG. 1 is a front elevation view, partly sectioned, of a toilet including an overflow control system in accordance with an embodiment.

FIG. 2a is a front elevation view of an obstruction sensor of the overflow control system of FIG. 1, in accordance with an embodiment, wherein the obstruction sensor is in a normal operation configuration.

FIG. 2b is a front elevation view of the obstruction sensor of FIG. 2a, in an overflow configuration.

FIG. 3 is a flowchart of a method for preventing toilet overflows in accordance with an embodiment.

It will be noted that throughout the appended drawings, like features are identified by like reference numerals.

### DETAILED DESCRIPTION

Moreover, although the embodiments of the toilet including a toilet overflow control assembly and corresponding parts thereof consist of certain geometrical configurations as explained and illustrated herein, not all of these components and geometries are essential and thus should not be taken in their restrictive sense. It is to be understood, as also apparent to a person skilled in the art, that other suitable components and cooperation thereinbetween, as well as other suitable geometrical configurations, may be used for the toilet and its toilet overflow control assembly, as will be briefly explained herein and as can be easily inferred herefrom by a person skilled in the art. Moreover, it will be appreciated that positional descriptions such as “above”, “below”, “left”, “right” and the like should, unless otherwise indicated, be taken in the context of the figures and should not be considered limiting.

In the following description, the same numerical references refer to similar elements. Furthermore, for the sake of simplicity and clarity, namely so as to not unduly burden the figures with several references numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures are optional, and are given for exemplification purposes only.

Moreover, it will be appreciated that positional descriptions such as “above”, “below”, “forward”, “rearward” “left”, “right” and the like should, unless otherwise indicated, be taken in the context of the figures and correspond to the position and orientation of the toilet and corresponding parts when installed and connected to a system of pipes. Positional descriptions should not be considered limiting.

To provide a more concise description, some of the quantitative expressions given herein may be qualified with the term “about”. It is understood that whether the term “about” is used explicitly or not, every quantity given herein is meant to refer to an actual given value, and it is also meant to refer to the approximation to such given value that would reasonably be inferred based on the ordinary skill in the art, including approximations due to the experimental and/or measurement conditions for such given value.

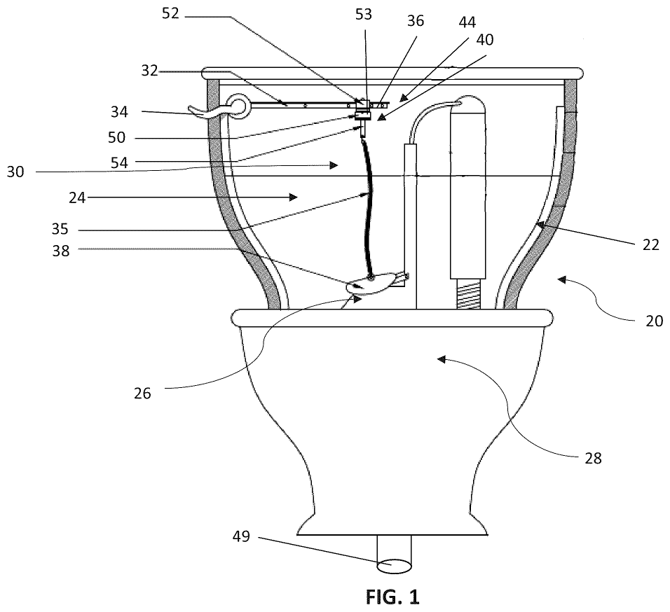

Referring now to the Figures and, more particularly to FIG. 1, there is shown a toilet 20 including a toilet tank 22 (also referred to as water tank) shown in cross-section. The toilet tank 22 defines a flush water receptacle 24 and has a toilet tank drain 26 defined therein, in a lower wall thereof, through which water can flow outwardly of the flush water receptacle 24. The toilet 20 also includes a toilet bowl 28 having a cavity in water communication with the flush water receptacle 24 of the toilet tank 22, through the toilet tank drain 26. Water flowing outwardly of the flush water receptacle 24 flows into the cavity of the toilet bowl 28.

The toilet 20 also includes a flush valve 30 mounted to the toilet tank 22. The flush valve 30 includes a flush actuator 32, a flapper 38 (also referred to as stopper), and a link 35 connecting the flush actuator 32 to the flapper 38. The flush actuator 32 has a portion extending outwardly of the toilet tank 22 and a portion extending inwardly of the toilet tank 22, as it will be described in more details below.

In the non-limitative embodiment shown, the flush actuator 32 includes a flush handle (or lever) 34 pivotably mounted to the toilet tank 22 and extending outwardly thereof. It also includes a float rod 36 (also referred to as tank lever) operatively connected to the flush handle 34 and pivoting simultaneously therewith. It is appreciated that, in an alternative embodiment (not shown), the flush actuator 32 can include a push button (such as a dual-flush button) in replacement of the flush handle 34 shown.

The flapper 38 is mounted to the toilet tank 22 and superposable to the toilet tank drain 26 to cover same. The link 35 operatively connects the flush actuator 32 and the flapper 38. The flapper 38 is configurable into a closed configuration wherein the flapper 38 covers the toilet tank drain 26, preventing water from flowing into the cavity of the toilet bowl 28, and an open configuration allowing water communication between the flush water receptacle 24 and the toilet tank drain 26. In the open configuration of the flapper 38, water contained in the flush water receptacle 24 can flow into the cavity of the toilet bowl 28.

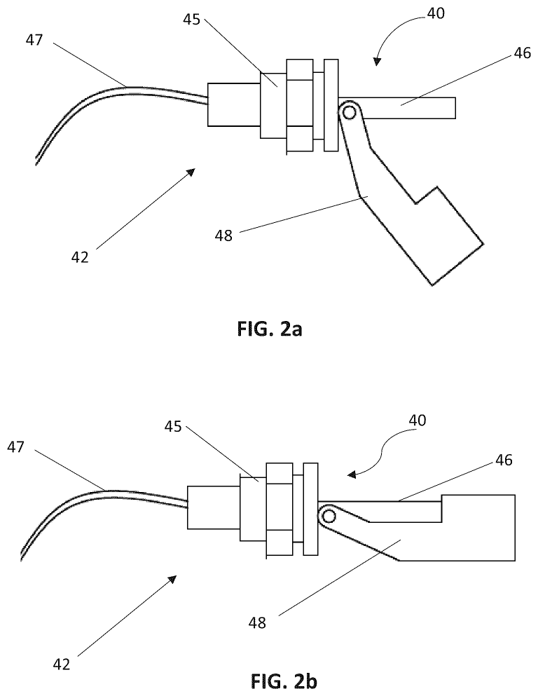

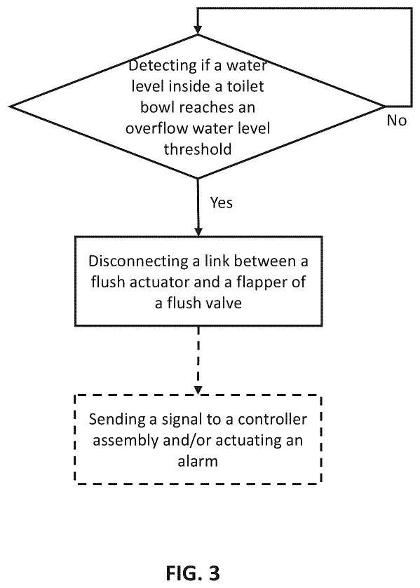

The toilet 20 also includes a toilet overflow control assembly 40 (only a portion thereof being shown in FIG. 1). The toilet overflow control assembly 40 includes an obstruction sensor 42 (shown in FIGS. 2a and 2b) and a flush valve disconnection mechanism 44 (shown in FIG. 1). The obstruction sensor 42 is operatively connected to the toilet bowl 28 to detect if a water level in the cavity of the toilet bowl 28 reaches an overflow water level threshold. Referring now to FIGS. 2a, 2b, and 3, a non-limitative embodiment of the obstruction sensor 42 is shown. The obstruction sensor 42 is configured to be mounted to an upper edge (or to a rim) of the toilet bowl 28 using a support bracket 45. The obstruction sensor 42 is embodied by a safety float configurable between two configurations: a normal operation configuration (FIG. 2a) and an overflow configuration (FIG. 2b) corresponding to a water level, inside the cavity of the toilet bowl 28, equal or greater than the overflow water level threshold. More particularly, in the non-limitative embodiment shown, the safety float 42 has a main body 46 and a floating portion 48 pivotally mounted to the main body 46. The floating portion 48 is buoyant and rises with the water level in the cavity of the toilet bowl 28 between the normal operation configuration and the overflow configuration.

The safety float 42 is configured in the normal operation configuration when the water level in the cavity of the toilet bowl 28 is below the overflow water level threshold. In the non-limitative embodiment shown, in the normal operation configuration, the floating portion 48 defines a non-void angle with the main body 46 and, more particularly, the floating portion 48 extends below the main body 46. In the overflow configuration, the floating portion 48 is aligned with the main body 46, e.g. a substantially void angle is defined in between, or they extend at a same level.

The toilet bowl 28 has a toilet drain 49 defined therein through which water contained in the cavity of the toilet bowl 28 is evacuated into a toilet drainpipe (not shown). When the toilet drain 49 is blocked, the water level in the cavity of the toilet bowl 28 rises each time the flush actuator 32 is actuated. While the water level rises into the cavity of the toilet bowl 28, the floating portion 48 of the safety float 42 pivots about a pivoting connection connecting the floating portion to the main body 46 since the floating portion 48 is buoyant and rises with the water level inside the cavity of the toilet bowl 28.

As the floating portion 48 reaches a certain angle with respect to the water level (e.g., substantially aligned with the main body 46 in the non-limitative embodiment shown), the configuration of the safety float 42 switches from the normal operation configuration to the overflow configuration.

In alternative embodiments, it is appreciated that other types of obstruction sensor 42 can be used, in addition to or in replacement of the safety float, such as an optical sensor, a pressure sensor, a humidity sensor, or any other type of sensors.

It is appreciated that the shape and the configuration of the support bracket 45 can vary from the embodiment shown. In an alternative embodiment, the obstruction sensor 42 can be mounted directly to the toilet bowl 28.

The obstruction sensor 42, e.g., the safety float in the embodiment shown, is in data communication with at least one other component of the toilet overflow control assembly 40. More particularly, in the non-limitative embodiment shown, a communication wire 47 connects the obstruction sensor 42 to at least one other component. Therefore, the configuration of the obstruction sensor 42 can be communicated, at least in the overflow configuration. More particularly, when the obstruction sensor is configured in the overflow configuration, information is sent to signal that a toilet bowl overflow is about to happen, e.g., the water level inside the cavity of the toilet bowl 28 reached the overflow water level threshold.

It is appreciated that data communication regarding the configuration of the obstruction sensor 42 can be carried out through different communication means than the wired communication embodiment, shown in FIGS. 2a and 2b. For instance and without being limitative, data communication can occur through a digital signal, an analog signal (with a potentiometer at the pivot point of the main body 46), a wireless communication, a mechanical communication, or any other suitable communication means.

Referring back to FIG. 1, there is shown that the disconnection mechanism 44 is mounted to the flush valve 30 of the toilet 20 and operatively connected to the obstruction sensor 42. The disconnection mechanism 44 is configurable into an operative configuration wherein the flush actuator 32 is operatively connected to the flapper 38 and a disengaged configuration wherein the flush actuator 32 is disconnected from the flapper 38 upon detection of a water level, inside the cavity of the toilet bowl 28, equal or greater than the overflow water level threshold. Therefore, in the operative configuration, activation of the flush actuator 32 configures the flapper 38 in an open configuration, exposing the toilet tank drain 26, and allowing water contained in the flush water receptacle 24 to flow into the cavity of the toilet bowl 28. In the disengaged configuration, the flapper 38 remains in the closed configuration, sealing the toilet tank drain 26, even if the flush actuator 32 is activated.

The toilet drain 49 of the toilet bowl 28 can be partially or totally clogged, limiting the water flow through the toilet drain 49, when the flush actuator 32 is activated. At the same time, water flows from the toilet tank 22 to the cavity of the toilet bowl 28. If the toilet bowl drain 49 is partially or totally clogged, the water level in the cavity of the toilet bowl 28 gradually rises if the flush actuator 32 is activated several times. At some point, the water level in the cavity of the toilet bowl 28 reaches a rim of the toilet bowl 28 and an overflow occurs. If the actuator 32 is further activated, water continues to flow over the toilet bowl 28.

Thus, configuring the flush valve disconnection mechanism 44 in the disconnected configuration once the overflow water level threshold is reached inside the cavity of the toilet bowl prevents additional water supply to the toilet bowl 28 and, therefore, occurrence of a toilet bowl overflow.

In the non-limitative embodiment shown, the disconnection mechanism 44 comprises an electromagnet assembly 50 connecting the flush actuator 32 to the link 35 and the flapper 38. In the non-limitative embodiment shown, the electromagnet assembly 50 is mounted between the flush actuator 32 and the link 35. More particularly, in the embodiment shown, the disconnection mechanism 44 includes an electromagnet support 52 mounted to the float rod 36 and supporting an electromagnet 53 of the electromagnet assembly 50. The electromagnet assembly 50 further includes a metallic support 54 mounted to an end of the link 35, opposed to the flapper 38. In the operative configuration, the metallic support 54 is engaged with the electromagnet 53. In the disengaged configuration, the metallic support 54 is disengaged with the electromagnet 53 and, more particularly, they are spaced-apart. The electromagnet 53 remains mounted to the flush actuator 32 via the electromagnet support 52, while the metallic support 54 falls in a bottom of the toilet tank 22. In the embodiment shown, the electromagnet 53 is located above a maximum water level in the toilet tank 22.

It is appreciated that the electromagnet assembly 50 can differ from the embodiment shown. For instance and without being limitative, the metallic support 54 can be mounted to the flush actuator 32 and the electromagnet 53 can be mounted to the link 35. In an embodiment, the electromagnet 53 can be mounted directly, i.e. without the electromagnet support 52. In an alternative embodiment, the link 35 can be dividable into two sections with the electromagnet assembly 50 being mounted between the two sections. In still another embodiment, the electromagnet assembly 50 can be mounted between the link 35 and the flapper 38.

When electric current is supplied to the electromagnet assembly 50, the flush actuator 32 is connected to the link 35, via the electromagnet assembly 50. However, when the water level, inside the cavity of the toilet bowl 28, reaches the overflow water level threshold, detected by the obstruction sensor 42, no electric current is supplied to the electromagnet assembly 50, as will be described in more details below. The electromagnet 53 releases the metallic support 54 and, thereby, the flush actuator 32 is disconnected from the link 35, making it impossible to flush the toilet 20, i.e. to evacuate water contained in the flush water receptacle 24 into the cavity of the toilet bowl 28 through the toilet tank drain 26, thereby preventing toilet bowl overflow.

It is appreciated that the disconnection mechanism 44 can differ from the electromagnet assembly 50.

In the embodiment shown, the toilet overflow control assembly 40 further includes at least one battery, for example a 12V battery, operatively connected to the electromagnet assembly 50, working as a power supply. A low voltage circuit reduces the risk of electrical accident and is safer that a standard voltage (e.g., 120V) for an application with water. A second advantage of using batteries is that the toilet overflow system is operable and functional even during a power outage.

In the embodiment shown in FIG. 1, the toilet overflow control assembly 40 further includes a controller assembly (not shown) operatively connected to the obstruction sensor 42 and the disconnection mechanism 44. Therefore, the signal associated to the configuration of the obstruction sensor 42 in the overflow configuration can be transferred from the obstruction sensor 42 to the controller assembly, which in turn, turns off the electric current supplied to the disconnection mechanism 44 and, more particularly, the electromagnet 53. Without electric current, the electromagnet 53 releases the metallic support 54 and, thereby, the flush actuator 32 is disconnected from the link 35, making it impossible to flush the toilet 20.

The toilet overflow control assembly 40 can further include an alarm (not shown), which can be directly or indirectly in data communication with the obstruction sensor 42. The alarm can be configurable in at least two states: an idle state corresponding to a normal operation configuration of the obstruction sensor 42 and an alarm state corresponding to the overflow configuration of the obstruction sensor 42. The alarm can signal the overflow by many ways. It can be an audible alarm, a visual alarm, or any other suitable alarm or combination thereof. The alarm can also be operatively connected to a household alarm, a building alarm, or any other centralized alarm system.

The controller assembly can also optionally include a screen that displays the count of overflows and a visual alarm, such as a light.

Referring to FIG. 3, there is a method to prevent a toilet overflow. The method comprises: detecting if a water level inside the cavity of the toilet bowl 28 of the toilet 20 reaches an overflow water level threshold and, if the overflow water level threshold is reached, disconnecting the flush actuator 32 from the flapper 38 of the flush valve 30.

In an embodiment, the water level inside the cavity of the toilet bowl 28 is monitored with the obstruction sensor 42, such as the safety float. When the water lever inside the cavity of the toilet bowl 28 reaches the overflow water level threshold, the obstruction sensor 42 is configured from the normal operation configuration to the overflow configuration. A signal is sent to the controller assembly, the alarm, and/or the disconnection mechanism 44.

Upon receiving the signal that the water level inside the cavity of the toilet bowl 28 is equal to or higher than the overflow water level threshold, the disconnection mechanism 44 is configured from the operative configuration to the disengaged configuration wherein the flush actuator 32 is disconnected from the flapper 38.

The method can also include actuating the alarm when the obstruction sensor 42 is configured in the obstruction configuration.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

It will be appreciated that the methods described herein may be performed in the described order, or in any suitable order.

Several alternative embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind. The scope of the invention is therefore intended to be limited solely by the scope of the appended claims.

1. A toilet comprising:
a toilet tank having a tank drain and defining a flush water receptacle;
a toilet bowl having a cavity in water communication with the flush water receptacle of the toilet tank;
a flush valve mounted to the toilet tank and including a flush actuator, a flapper mounted to the toilet tank and superposable to the tank drain to obstruct same, and a link operatively connecting the flush actuator and the flapper, the flapper being configurable into a closed configuration wherein the flapper obstructs the tank drain and an open configuration allowing water communication between the flush water receptacle and the tank drain; and
a toilet overflow control assembly including an obstruction sensor mounted to the toilet bowl to detect if a water level inside the cavity of the toilet bowl reaches an overflow water level threshold and a disconnection mechanism mounted to the flush valve and operatively connected to the obstruction sensor, the disconnection mechanism being configurable into an operative configuration wherein the flush actuator is operatively connected to the flapper and a disengaged configuration wherein the flush actuator is disconnected from the flapper if the obstruction sensor detects that the water level inside the cavity of the toilet bowl reaches the overflow water level threshold.

2. The toilet of claim 1, wherein the obstruction sensor comprises a safety float configurable into a normal configuration and an overflow configuration corresponding to the water level inside the cavity of the toilet bowl reaching the overflow water level threshold.

3. The toilet of claim 2, wherein the safety float is pivotally mounted to the toilet tank, a position of the safety float in the normal configuration being lower than in the overflow configuration.

4. The toilet of claim 1, wherein the disconnection mechanism comprises an electromagnet assembly.

5. The toilet of claim 4, wherein the electromagnet assembly comprises an electromagnet support mounted to one of the flush actuator and the link, and a metallic element mounted to the other one of the flush actuator and the link, the electromagnet support and the metallic element being engaged together in the operative configuration and being disengaged from one another in the disengaged configuration.

6. The toilet of claim 5, wherein the flush actuator comprises a pivotally-mounted float rod and at least one of a lever and a button operatively connected to the float rod to pivot same, and wherein the electromagnet support is mounted to the float rod.

7. The toilet of claim 4, wherein the electromagnet assembly is located above a maximum water level inside the flush water receptable.

8. The toilet of claim 1, wherein the toilet overflow control assembly further comprises a controller assembly operatively connected to at least one of the obstruction sensor and the disconnection mechanism.

9. The toilet of claim 1, wherein the toilet overflow control assembly comprises an alarm and the obstruction sensor is operatively connected to the alarm to configure the alarm is an alarm state when a toilet bowl overflow is detected.

10. The toilet of claim 1, wherein the flapper is pivotally mounted to the toilet tank and covers the tank drain in the closed configuration.

11. The toilet of claim 1, wherein the toilet overflow control assembly further comprises a battery operatively connected to the disconnection mechanism.

12. A toilet overflow control assembly for a toilet including a toilet tank, a toilet bowl, and a flush valve mounted to the toilet tank, the toilet overflow control assembly comprising:
an obstruction sensor engageable with the toilet bowl to detect if a water level inside a cavity of the toilet bowl reaches an overflow water level threshold; and
a disconnection mechanism connectable to the flush valve between a flush actuator and a flapper of the flush valve and operatively connected to the obstruction sensor, the disconnection mechanism being configurable into an operative configuration wherein the flush actuator is operatively connected to the flapper and a disengaged configuration wherein the flush actuator is disconnected from the flapper if the obstruction sensor detects that the water level inside the cavity of the toilet bowl reaches the overflow water level threshold.

13. The toilet overflow control assembly of claim 12, wherein the obstruction sensor comprises a safety float configurable into a normal configuration and an overflow configuration corresponding to the water level inside the cavity of the toilet bowl reaching the overflow water level threshold.

14. The toilet overflow control assembly of claim 12, wherein the flush valve further comprises a link connecting the flapper to the flush actuator, wherein the disconnection mechanism comprises an electromagnet assembly including an electromagnet support mounted to one of the flush actuator and the link, and a metallic element mounted to the other one of the flush actuator and the link, the electromagnet support and the metallic element being engaged together in the operative configuration and being disengaged from one another in the disengaged configuration.

15. The toilet overflow control assembly of claim 14, wherein the electromagnet assembly is located above a water level inside the toilet tank.

16. The toilet overflow control assembly of claim 12, further comprising a controller assembly operatively connected to the obstruction sensor and the disconnection mechanism and an alarm and the obstruction sensor is operatively connected to the alarm to configure the alarm is an alarm state when a toilet bowl overflow is detected.

17. The toilet overflow control assembly of claim 12 further comprising a battery operatively connected to the disconnection mechanism.

18. A method to prevent a toilet overflow, the method comprising:
detecting if a water level inside a cavity of a toilet bowl of a toilet reaches an overflow water level threshold; and
if the overflow water level threshold is reached, disconnecting a flush actuator from a flapper of a flush valve mounted to a toilet tank of the toilet.

19. The method of claim 18, further comprising actuating an alarm when the water level inside the cavity of the toilet bowl reaches the overflow water level threshold.

20. The method of claim 18, wherein disconnecting the flush actuator from the flapper of the flush valve of the toilet comprises cutting power supplied to an electromagnet assembly connecting the flush actuator to the flapper of the flush valve, thereby configuring the flapper in a closed configuration wherein the flapper obstructs a tank drain, thereby preventing water communication between the toilet tank and the cavity of the toilet bowl.
